(19) United States
(12) Patent Application Publication
(10) Pub. No.: US 2011/0250002 A1
(43) Pub. Date: Oct. 13, 2011

(54) ROTATABLE DOUBLE ENDED DEVICE

(76) Inventor: Ketan Vora, (US)

(21) Appl. No.: 13/072,370

(22) Filed: Mar. 25, 2011

Related U.S. Application Data
(60) Provisional application No. 61/321,937, filed on Apr. 8, 2010.

(51) Int. Cl. B43K 23/00

(52) U.S. Cl. 401/8

(57) ABSTRACT

A multi-tipped device is disclosed. The device includes a central ring to receive a finger; and first and second portions oppositely extended from the central ring, each of the first and second portions including an elongated housing extending from the central ring and a tip at a distal end of the housing, wherein the ring and the tip are rotatable around the finger.

This application claims priority to Provisional Application Ser. No. 61/321,937, filed Apr. 8, 2010, the content of which is incorporated by reference.

### BACKGROUND

The present invention relates to a rotatable double ended device.

Any discussion of the related art throughout the specification should in no way be considered as an admission that such related art is widely known or forms part of common general knowledge in the field.

Writing devices such as pens, highlighters, markers and the like have been in use for years. Previously existing writing devices are generally comprised of single-tip and multi-tipped varieties. A single-tip writing device will generally be comprised of an elongated shaft having a writing tip extending from a single end thereof.

Multi-tipped writing devices have come in a number of forms. These multi-tipped writing devices generally either include multiple writing tips present on a single end of an elongated shaft or a single writing tip on both opposing ends of an elongated shaft. In either case, it can be cumbersome and inefficient to switch between a plurality of tips.

With previously-existing devices having multiple tips on a single end, the tips are generally required to be of different length and complicated mechanisms may be required to switch between the tips. Further, when writing with such a device, the operator will sometimes accidentally write with two or more tips when intending to write with a single tip. With previously-existing devices having a single tip on opposing ends, it is often disruptive to the work being performed to switch between the ends.

Because of the inherent problems with the related art, there is a need for a new and improved rotatable double ended device having a central ring for efficiently switching between a pair of tips located on opposing ends of an elongated housing.

### SUMMARY

A multi-tipped device is disclosed. The device includes a central ring to receive a finger; and first and second portions oppositely extended from the central ring, each of the first and second portions including an elongated housing extending from the central ring and a tip at a distal end of the housing, wherein the ring and the tip are rotatable around the finger.

Implementations of the above device may include one or more of the following. The portion can be a tubular configuration with a circular cross-section. An opening can extend at least partially through a body length of the portion. The opening receives an object such as a battery, or an ink reservoir. The tip can be a pen tip, a pencil tip, a felt marker tip, a highlighter tip, a stylus tip, a laser pointer, or a flashlight, among others. The object can be fixedly or removably attached to the opening. A cushion portion such as rubber or a malleable material can be positioned near the central ring. The finger can rest on the cushion portion. A cap can be used to cover the tip. A depression can be formed near the central ring for ease of finger insertion.

In another aspect, a method for using a double-ended device having a central ring; and first and second portions oppositely extended from the central ring, each of the first and second portions including an elongated housing extending from the central ring and a tip at a distal end of the housing. A user can insert a finger through a central ring; and rotatably turn the tip of the device to the right area for writing or illuminating an area, among others. The method includes inserting a finger through the central ring, wherein a depression is proximal to the central ring to facilitate finger insertion.

### BRIEF DESCRIPTION OF THE DRAWINGS

Various other objects, features and attendant advantages of embodiments of the invention will become fully appreciated as the same becomes better understood when considered in conjunction with the accompanying drawings, in which like reference characters designate the same or similar parts throughout the several views, and wherein:

FIG. 1 is an upper perspective view of one embodiment of the double-ended device.

FIG. 2 is an upper perspective view of the device in use for writing.

FIG. 3 is an upper perspective view of the device being rotated around the finger of an operator.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

A. Overview.

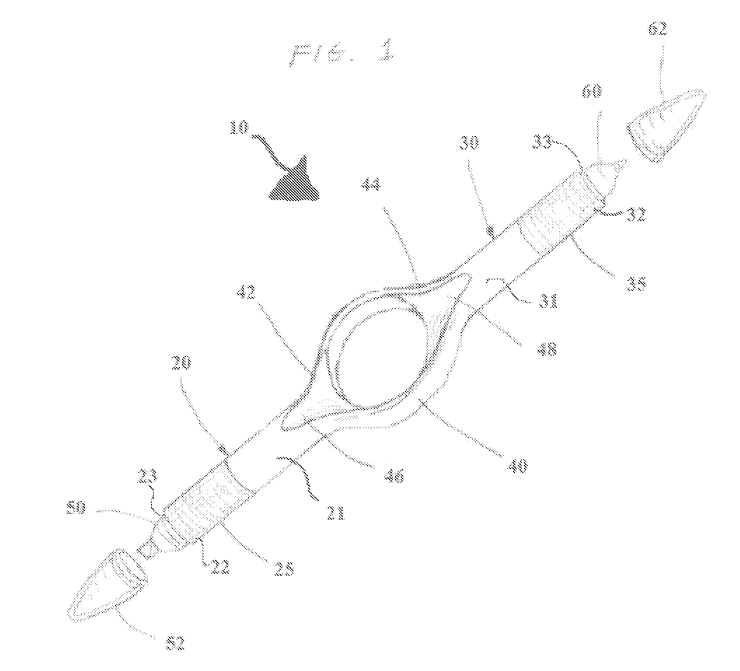

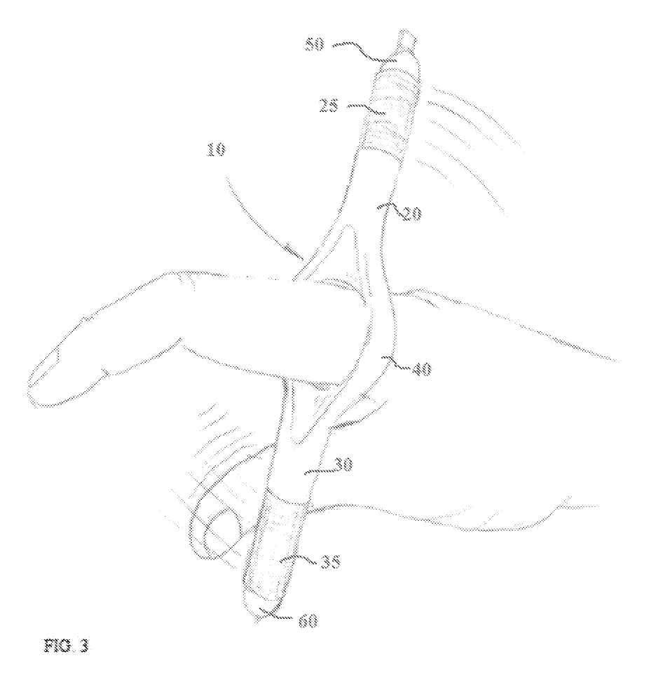

Turning now descriptively to the drawings, in which similar reference characters denote similar elements throughout the several views, FIGS. 1 through 3 illustrate a rotatable double ended device 10, which comprises an elongated device having a first portion 20 and a second portion extending in opposite directions from a central ring 40.

The first portion 20 will generally include a first tip 50 located at its distal end 22 and the second portion 30 will generally include a second tip 60 located at its distal end 32. By inserting a finger within the central ring 40, an operator of the device may easily alternate between use of the first tip 50 and use of the second tip 60.

B. First Portion.

The first portion 20 will generally be comprised of an elongated housing extending from the central ring 40 in a direction opposite of the second portion 30. The first portion 20 will preferably be comprised of a tubular configuration with a circular cross-section. However, it is appreciated that various other configurations may be utilized for the first portion 20, including the use of different cross-sections. The first portion 20 may be comprised of various materials, including plastics, metals, metal alloys, wood and the like. It is also appreciated that, in some embodiments, the first portion 20 will be integrally formed with the second portion 30 and the central ring 40.

The first portion 20 will generally include a first end 21 and a second end 22. The first end 21 of the first portion 20 will generally be comprised of the end of the first portion 20 which is adjacent the central ring 40. The second end 22 of the first portion 20 will generally be comprised of the distal end of the first portion 20 with respect to the central ring 40.

The first portion 20 will generally include a first opening 23 which extends at least 30 partially through the length of the body of the first portion 20 from its second end 22. The first opening 23 of the first portion 20 will generally be configured to accept and retain the first tip 50 of the embodiment. It is appreciated that the first opening 23 may have various cross-sections and may extend for the entire length of the first portion 20 or, in some embodiments, may only extend for a small area of the length of the first portion 20. It is also appreciated that the first opening 23 may store various other components of the preferred embodiment, including a battery, ink reservoir, etc.

The first portion 20 may also include a first cushion portion 25 positioned adjacent to its second end 22 as shown in FIG. 1. The first cushion portion 25 may be comprised of a soft, malleable material such as rubber or the like. An operator of the device may utilize the first cushion portion 25 for resting his/her finger when utilizing the first tip 50 of the embodiment. It is appreciated that the first cushion portion 25 may cover varying areas of the first portion 20 without affecting the overall operation of the embodiment. As such, the first cushion portion 25 should not be construed as being limited to the configuration shown in the figures. In some embodiments, the first cushion portion 25 may cover the entirety of the first portion 20 of the embodiment.

C. Second Portion.

The second portion 30 of the embodiment will generally be comprised of an elongated housing extending from the central ring 40 in a direction opposite of the first portion 20. The second portion 30 will preferably be comprised of a tubular configuration with a circular cross-section. However, it is appreciated that various other configurations may be utilized for the second portion 30, including the use of different cross-sections.

The second portion 30 may be comprised of various materials, including plastics, metals, metal alloys, wood and the like. It is also appreciated that, in some embodiments, the second portion 30 will be integrally formed with the first portion 20 and the central ring 40.

The second portion 30 will generally include a first end 31 and a second end 32. The first end 31 of the second portion 30 will generally be comprised of the end of the second portion 30 which is adjacent the central ring 40. The second end 32 of the second portion 30 will generally be comprised of the distal end of the second portion 30 with respect to the central ring 40.

The second portion 30 will generally include a second opening 33 which extends at least partially through the length of the body of the second portion 30 from its second end 32. The second opening 33 of the second portion 30 will generally be configured to accept and retain the second tip 60 of the embodiment. It is appreciated that the second opening 33 may have various cross-sections and may extend for the entire length of the second portion 30 or, in some embodiments, may only extend for a small area of the length of the second portion 30. It is also appreciated that the second opening 33 may store various other components of the embodiment, including a battery, ink reservoir, etc.

The second portion 30 may also include a second cushion portion 35 positioned adjacent to its second end 32 as shown in FIG. 1. The second cushion portion 35 may be comprised of a soft, malleable material such as rubber or the like. An operator of the embodiment may utilize the second cushion portion 35 for resting his/her finger when utilizing the second tip 60 of the embodiment. It is appreciated that the second cushion portion 35 may cover varying areas of the second portion 30 without affecting the overall operation of the embodiment. As such, the second cushion portion 35 should not be construed as being limited to the configuration shown in the figures. In some embodiments, the second cushion portion 35 may cover the entirety of the second portion 30 of the embodiment.

D. Central Ring.

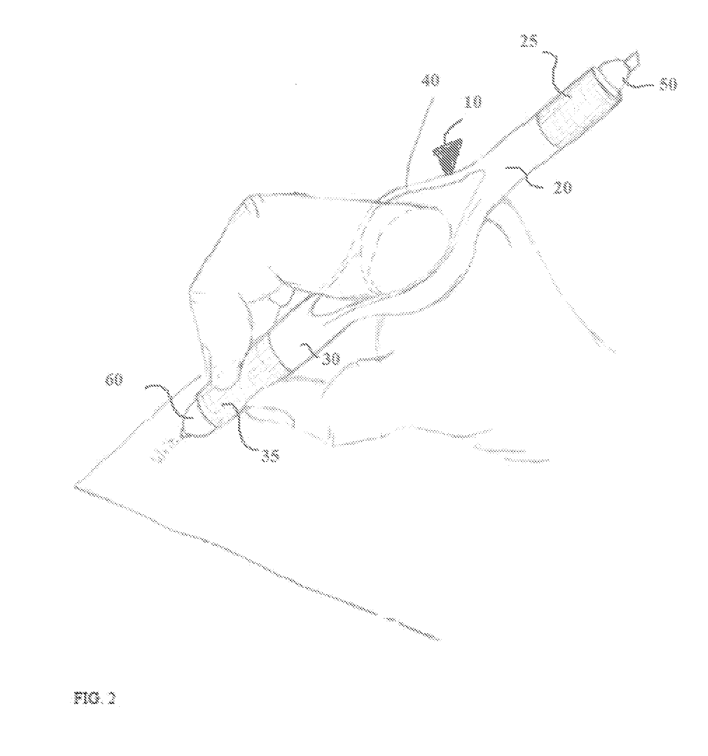

The embodiment will generally include a central ring 40 through which an operator of the embodiment may insert his/her finger when in use as shown in FIG. 2.

The central ring 40 will generally be comprised of a circular ring member positioned between the first end 21 of the first portion 20 and the first end 31 of the second portion 30 of the embodiment. However, it is appreciated that various other configurations and shapes may be utilized for the central ring 40, and it should be not be construed as being limited to the circular configuration shown in the figures. In some embodiments, the central ring 40 may be comprised of a square shape, elliptical shape or various other shape, so long as an operator of the embodiment may easily insert his/her finger within the central ring 40 to rotate the embodiment.

E. Tips.

The embodiment will generally include a first tip 50 extending from the first opening 23 of the first portion 20 and a second tip 60 extending from the second opening 33 of the second portion 30 as shown in FIG. 1. Various types of tips may be utilized, including tips for pens, pencils, felt markets, highlighters, styluses, laser pointers, flashlights and the like. It is appreciated that various combinations of the foregoing may be utilized with the embodiment. For example, in one embodiment, the first tip 50 may be comprised of a pen and the second tip 60 may be comprised of a flashlight.

The tips 50, 60 of the embodiment may be fixedly attached within the respective openings 23, 33 or, in a preferred embodiment, may be removably attached within the respective openings 23, 33 so as to allow an operator of the embodiment to interchange tips 50, 60 for various different applications. It is appreciated that various methods may be utilized for effectuating the removable attachment of the tips 50, 60, including push buttons, slides and the like.

The embodiment may also include a first cap 52 for covering the first tip 50 and a second cap 62 for covering the second tip 60 as illustrated in the figures. The caps 52, 62 may be comprised of structures which act to cover the respective tips 50, 60 when they are not in use.

F. Operation of Preferred Embodiment.

In use, the operator of the embodiment will first select a tip 50, 60 to be utilized. When using the first tip 50, the operator will insert his/her finger through the central ring 40 as shown in FIG. 2. The operator may extend his/her finger over the first depression 46. The first tip may then be utilized for writing, illuminating areas or various other functions. When writing, the operator may rest one or more of his/her fingers against the first cushion portion 25 to provide additional comfort during use.

Upon deciding to utilize the second tip 60, the operator will generally rotate the embodiment by rotating the central ring 40 about his/her finger. After rotating the embodiment 180 degrees using the central ring 40, the operator may utilize the second tip 60 for writing, illuminating areas or various other functions.

Unless otherwise defined, all technical and scientific terms used herein have the same meaning as commonly understood by one of ordinary skill in the art to which this invention belongs. Although methods and materials similar to or equivalent to those described herein can be used in the practice or testing of the embodiment, suitable methods and materials are described above. All publications, patent applications, patents, and other references mentioned herein are incorporated by reference in their entirety to the extent allowed by applicable law and regulations. In case of conflict, the present specification, including definitions, will control. The embodiment may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The central ring 40 will generally include a first end 42 and a second end 44. The first end 42 of the central ring 40 will generally be positioned adjacent the first end 21 of the first portion 20. The second end 44 of the central ring 40 will generally be positioned adjacent the first end 31 of the second portion 30. It is also appreciated that, in some embodiments, the central ring 40 may be integrally formed with both the first portion 20 and the second portion 30 of the embodiment.

The central ring 40 will generally include a first depression 46 and a second depression 48 as shown in FIG. 1. The first depression 46 will generally be positioned at the junction between the first portion 20 and the first end 42 of the central ring 40. The second depression 48 will generally be positioned at the junction between the second portion 30 and the second end 44 of the central ring 40.

The depressions 46, 48 of the embodiment will generally be comprised of depressed areas at the first end 42 and the second end 44 of the central ring 40. The first depression 46 will generally be tapered in width in the direction of the first portion 20. The second depression 48 will generally be tapered in width in the direction of the second portion 30. Thus, the width of the inner edges of the central ring 40 adjacent its first and second ends 42, 44 will be narrower than the width of the inner edges of the remainder of the central ring 40. Such a configuration of the depressions 46, 48 provides comfort for the insertion of an operator's finger and facilitates the bending of the inserted finger in a writing position.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A multi-tipped device, comprising:
a central ring to receive a finger; and
first and second portions oppositely extended from the central ring, each of the first and second portions including an elongated housing extending from the central ring and a tip at a distal end of the housing, wherein the ring and the tip are rotatable around the finger.

2. The device of claim 1, wherein one portion comprises a tubular configuration with a circular cross-section.

3. The device of claim 1, wherein one portion comprises include an opening extending at least partially through a body length of the portion.

4. The device of claim 3, wherein the opening receives an object.

5. The device of claim 4, wherein the object includes one of: a battery, an ink reservoir.

6. The device of claim 4, wherein the tip comprises one of: a pen tip, a pencil tip, a felt marker tip, a highlighter tip, a stylus tip, a laser pointer, a flashlight.

7. The device of claim 4, wherein the object is fixedly attached to the opening.

8. The device of claim 4, wherein the object is removably attached to the opening to allow an operator to interchange tips.

9. The device of claim 1, wherein one portion comprises a cushion portion positioned near the central ring.

10. The device of claim 9, wherein the cushion portion comprises rubber or a malleable material.

11. The device of claim 9, wherein the finger rests on the cushion portion.

12. The device of claim 4, comprising a cap to cover the tip.

13. The device of claim 1, comprising a depression near the central ring for ease of finger insertion.

14. A method for using a double-ended device having a central ring; and first and second portions oppositely extended from the central ring, each of the first and second portions including an elongated housing extending from the central ring and a tip at a distal end of the housing, the method comprising:
inserting a finger through a central ring; and
rotatably using the tip for writing or illuminating an area.

15. The method of claim 14, comprising forming one portion in a tubular configuration with a circular cross-section.

16. The method of claim 14, comprising providing an opening extending at least partially through a body length of the portion.

17. The method of claim 16, comprising inserting an object into the opening.

18. The method of claim 17, wherein the object includes one of: a battery, an ink reservoir.

19. The method of claim 17, wherein the tip comprises one of: a pen tip, a pencil tip, a felt marker tip, a highlighter tip, a stylus tip, a laser pointer, a flashlight.

20. The method of claim 17, wherein the object is fixedly attached to the opening or removably attached to the opening to allow an operator to interchange tips.

21. The method of claim 17, comprising inserting a finger through the central ring, wherein a depression is proximal to the central ring to facilitate finger insertion.

22. The method of claim 14, whereas a finger inserted in the central ring with a depression proximal to the central ring facilitates use.
